(19) United States
(12) Patent Application Publication
(10) Pub. No.: US 2015/0222697 A1
(43) Pub. Date: Aug. 6, 2015

(54) CONSOLIDATED ACCESS TO BROADCAST CONTENT AVAILABLE FROM DIFFERENT NETWORKS

(71) Applicant: QUALCOMM Incorporated, San Diego, CA (US)

(72) Inventors: Nermeen Ahmed Bassiouny, San Diego, CA (US); Thadi Manjunath Nagaraj, San Diego, CA (US); Carlos Marcelo Dias Pazos, Carlsbad, CA (US)

(21) Appl. No.: 14/458,921

(22) Filed: Aug. 13, 2014

Related U.S. Application Data
(60) Provisional application No. 61/934,219, filed on Jan. 31, 2014.

(51) Int. Cl. H04L 29/08; H04L 12/18; H04L 29/12

(52) U.S. Cl. CPC H04L 67/1002; H04L 61/1511; H04L 12/18

(57) ABSTRACT

In one example, a device for retrieving media data includes a middleware unit configured to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

This application claims the benefit of U.S. Provisional Application Ser. No. 61/934,219, filed Jan. 31, 2014, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data (and/or other media data, such as audio and/or timed text data) has been encoded, the media data may be packetized for transmission or storage. The packetized media data may be sent using a unicast protocol, such as hypertext transfer protocol (HTTP), or a broadcast or multicast protocol, such as Enhanced Multimedia Broadcast Multicast Service (eMBMS).

### SUMMARY

In general, this disclosure describes techniques for processing media data. In particular, the techniques of this disclosure include abstracting retrieval of media data for a service from two or more networks, which are potentially different types of networks. For instance, a middleware unit may determine services available from each of a plurality of networks, which may include different types of networks (e.g., eMBMS networks, LTE networks, Wi-Fi networks, or the like). The middleware unit may form an aggregate list of services and provide the list to an application. The application may send data representing a selection of one of the services to the middleware unit. The middleware unit may then retrieve media data for the selected service from an appropriate one of the networks, and provide the media data to the application.

In one example, a method of retrieving media data includes determining a first set of one or more services available via a first network of a first type, determining a second of one or more services available via a second network of a second type, producing an aggregate list of services including the first set of services and the second set of services, receiving a selection of a service from the aggregate list of services, and retrieving media data of the selected service from either the first network or the second network.

In another example, a device for retrieving media data includes a middleware unit configured to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

In another example, a computer-readable storage medium has stored thereon instructions that, when executed, cause a processor implementing a middleware unit of a client device to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system including example server devices and an example client device that may operate according to the techniques of this disclosure.

FIG. 2 is a conceptual diagram illustrating an example arrangement of units in accordance with the techniques of this disclosure.

FIG. 3 is a block diagram illustrating an example arrangement of components for a middleware unit in accordance with the techniques of this disclosure.

FIG. 4 is a flowchart illustrating an example method for processing media data in accordance with the techniques of this disclosure.

FIG. 5 is a conceptual diagram illustrating an example graphical user interface (GUI) 250 for selecting a service.

FIG. 6 is a conceptual diagram illustrating an example graphical user interface (GUI) 260 for displaying video content of a selected service.

### DETAILED DESCRIPTION

In general, this disclosure describes techniques that may be performed by a middleware unit of a client device for providing a list of available services to, e.g., a media application of the client device. The client device may be communicatively coupled to a plurality of different networks simultaneously, e.g., two or more of a wireless (Wi-Fi) network, a radio access network (RAN), a Third Generation Partnership Project (3G) network, a Long-Term Evolution (LTE) (also referred to as a Fourth Generation (4G)) network, a Multimedia Broadcast Multicast Services (MBMS) network, an enhanced MBMS (eMBMS) network, a wired Ethernet network, or the like. The client device need not necessarily remain connected to each of the networks simultaneously. For instance, the client device may connect to each of the various networks in a round-robin fashion.

The middleware unit of the client device may determine services that are available via each of the available networks, that is, the networks to which the client device is connected or can be connected. The services may correspond to individual sets of media content that can be delivered via a particular protocol over the corresponding network. For example, each service may correspond to a particular movie or television show that can be delivered via the network. The middleware unit may determine which services are available on each of the available networks.

In accordance with the techniques of this disclosure, the middleware unit may then assemble a list of available services from each of the networks. However, the middleware unit need not specifically identify the network from which each service is available. The middleware unit may provide the list of services to a media application. In this manner, a user of the media application may select a service from the list of services to be played out. In response to receiving a selection of a service from the media application, the middleware unit may determine which network the service is available from and retrieve data for the service from that network.

In this manner, the media application can be agnostic as to the network, and therefore, need not be configured to perform protocols used to interact with the network when selecting a service. The middleware unit may act as a proxy for a server on the network, such that the media application may retrieve data from the middleware unit as if the middleware unit were a server, e.g., in accordance with a network streaming protocol, such as Dynamic Adaptive Streaming over HTTP (DASH).

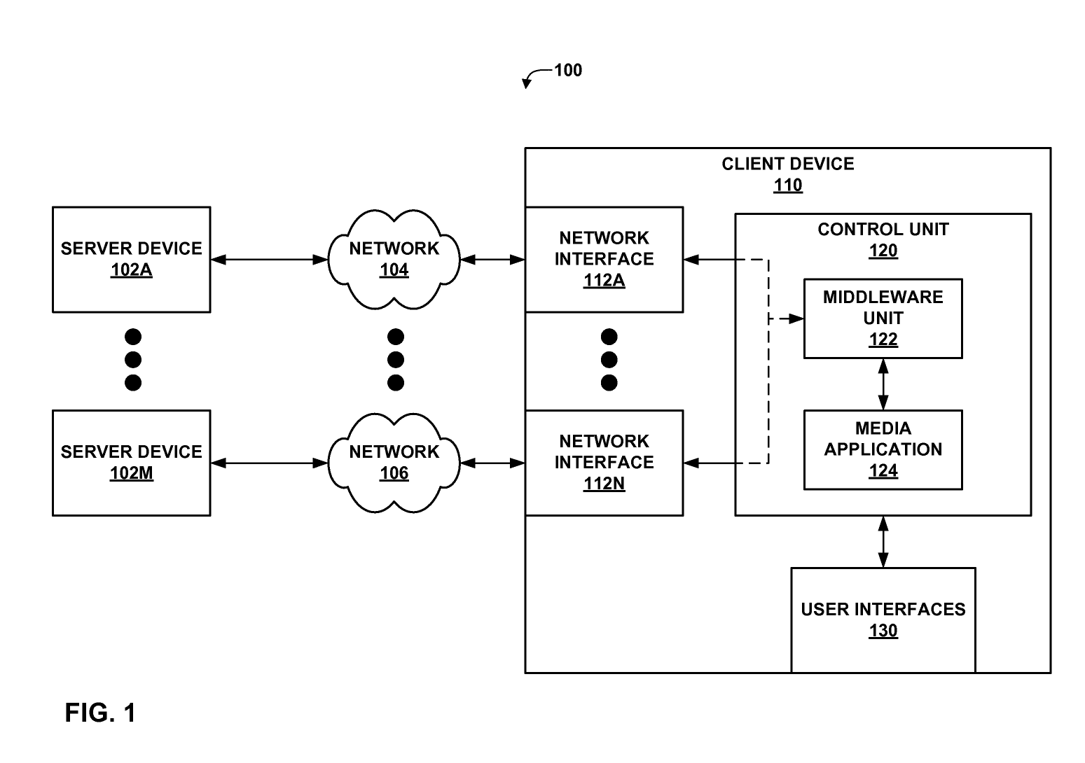

FIG. 1 is a block diagram illustrating an example system 100 including example server devices 102A-102M (server devices 102) and an example client device 110 that may operate according to the techniques of this disclosure. In this example, server devices 102 provide media data (e.g., audio and/or video data) via respective networks 104, 106. Although server devices 102 are communicatively coupled to different networks in the example of FIG. 1, it should be understood that the same server device may be communicatively coupled to two or more networks in some examples.

Server devices 102 generally provide media data via one or more of networks 104, 106. Server devices 102 may act as unicast, broadcast, and/or multicast servers. Networks 104, 106 may represent any of a variety of different types of networks. For example, these networks may include Ethernet-based wired networks, radio access networks (RANs), such as long-term evolution (LTE) networks, third generation (3G) networks, wireless networks conforming to one or more IEEE 802.11 standards (e.g., Wi-Fi networks), eMBMS networks, or the like. 3G networks may correspond to networks that conform to the International Mobile Telecommunications-2000 (IMT-2000) standards promulgated by the International Telecommunication Union.

Client device 110 represents a client device for retrieving media content via various networks, such as networks 104, 106. In this example, client device 110 includes network interfaces 112A-112N (network interfaces 112). In general, network interfaces 112 represent interfaces for interacting with different types of networks. For instance, network interfaces 112 may include any or all of a physical Ethernet network interface card (NIC), an LTE NIC, a wireless NIC conforming to one or more IEEE 802.11 standards (e.g., Wi-Fi), Enhanced Multimedia Broadcast Multicast Service (eMBMS), a wireless radio, a radio access network (RAN) radio for, e.g., a Third Generation Partnership Project (3G) network or a Fourth Generation (4G)/Long-Term Evolution (LTE) network, or the like.

Client device 110 also includes control unit 120 and user interfaces 130. Control unit 120 may represent one or more hardware-based processing units, e.g., one or more general purpose microprocessors, processing cores, digital signal processors (DSPs), application specific integrated circuits (ASICs), field programmable logic arrays (FPGAs), or other equivalent integrated or discrete logic circuitry, alone or in any combination. Likewise, functionality attributed to control unit 120, including units or modules within control unit 120 (such as middleware unit 122 and media application 124), may be implemented solely or in any combination of hardware, software, and/or firmware. When implemented in software or firmware, it is presumed that control unit 120 includes requisite hardware, e.g., one or more computer-readable media for storing instructions and one or more hardware-based processors for executing the instructions.

User interfaces 130 may include one or more user interfaces such as a display, a touchscreen, speakers, a microphone, pointing devices such as a mouse or touchpad, a keyboard, or the like. Although not shown in FIG. 1, client device 110 may include one or more media decoders, such as one or more audio decoders and one or more video decoders. Such decoders may be provided within control unit 120 or separate from control unit 120, e.g., between control unit 120 and user interfaces 130. Alternatively, the decoders may be provided between middleware unit 122 and media application 124.

In this example, control unit 120 includes middleware unit 122 and a media application 124. Media application 124 may correspond to an application for playing media data, such as video and/or audio data. When playing the media data, media application 124 may send decoded media data to user interfaces 130 for output. Furthermore, media application 124 may retrieve media data from middleware unit 122. Media application 124 may, for example, be configured to perform DASH, e.g., to retrieve media data from middleware unit 122 using techniques of DASH. Middleware unit 122 may generally act as an intermediate unit between media application 124 and network interfaces 112, such that the functionality for obtaining media data from server devices 102 via networks 104, 106 can be abstracted from media application 124. That is, media application 124 need not interact with modules or units related to networks 104, 106, such as network interfaces 112. Instead, media application 124 may interact with middleware unit 122, and middleware unit 122 may be responsible for controlling network interactions via network interfaces 112 on behalf of media application 124.

In some examples, middleware unit 122 may receive broadcast content from one or more of networks 104, 106. Middleware unit 122 may buffer the broadcast content. Then, middleware unit 122 may act as a proxy server with respect to media application 124. That is, media application 124 may send HTTP GET or partial GET requests to middleware unit 122. The GET or partial GET requests may specify segments (that is, files) of content to be retrieved, e.g., URLs of the segments. A base portion of the URLs may correspond to a localhost address of client device 110, such that the requests are directed to middleware unit 122, rather than to one or more of networks 104, 106.

In accordance with the techniques of this disclosure, middleware unit 122 may be configured to determine whether broadcast content (which may, additionally or alternatively, include multicast content) is available on any or all of networks 104, 106. Middleware unit 122 may determine each of networks 104, 106 on which broadcast content is available, and then present a list of available broadcast content to media application 124. However, middleware unit 122 may omit indications of networks 104, 106 from which the content is available in the list presented to media application 124. Media application 124, in turn, may present a list of available broadcast content via user interfaces 130 to a user and receive a selection from among the available broadcast content from the user. Media application 124 may then request the selected broadcast content from middleware unit 122. Middleware unit 122 may then determine from which of networks 104, 106 the selected broadcast content is available, and then obtain media data for the selected broadcast content via the network from which the selected broadcast content is available.

The list of services may be provided in any format, e.g., as a text file, a binary file, an extensible markup language (XML) file, a JavaScript Object Notation (JSON) file, or the like. The information included in the list may be dependent on the application to which the list is provided. In accordance with the techniques of this disclosure, the list need not identify networks from which the services are available. An example set of JSON data is shown below:

{
“message”:{

“appInstanceId”:“AppID_1”,
“body”:{

“groupInfo”:{
“currentGroup”:{

“groupName”:“Group1”,
“serviceAreaIdList”:[
],
“serviceHandleList”:[

1,
2

]

```
  },
  “groupList”:[
  ]
},
“serviceInfoList”:[
  {
```

“mpdUri”:“http://hostname:4009/service_1/www.example.com/fragments/mpd-
1.mpd”,

“serviceAvailability”:0,
“serviceClass”:“urn:Serviceid:1”,
“serviceHandle”:1,
“serviceId”:“metadata-service1-1”,
“serviceLanguage”:“string”,
“serviceName”:[

```
{
  “lang”:“”,
  “name”:“service1”
}
```

]

```
  },
  {
```

“mpdUri”:“http://hostname:4009/service_2/www.example.com/fragments/mpd-
2.mpd”,

“serviceAvailability”:0,
“serviceClass”:“urn:Serviceid:2”,
“serviceHandle”:2,
“serviceId”:“metadata-service2-2”,
“serviceLanguage”:“string”,
“serviceName”:[

```
{
  “lang”:“”,
  “name”:“service2”
}
```

]

}
]

}

}
}

In some examples, the same content may be available from two or more of networks 104, 106. In such instances, middleware unit 122 may be configured with priority information for networks 104, 106. For example, an eMBMS network may have a higher priority than a Wi-Fi network, or vice versa. Thus, when middleware unit 122 receives a selection of content available from two or more networks, middleware unit 122 may elect to retrieve the content from the network having the highest priority.

As noted above, middleware unit 122 may be configured to determine various sets of media content available from networks 104, 106. Middleware unit 122 may be configured to determine services (that is, sets of media content) available through a particular network in accordance with particular techniques for that network. For example, for an eMBMS network, middleware unit 122 may retrieve service discovery channel information from a provisioned unicast location. That is, the eMBMS network may have a particular server that responds to HTTP requests or other unicast requests. The server at the unicast location may indicate a service discovery channel. Middleware unit 122 may then download a service announcement via the service discovery channel, e.g., using a service discovery eMBMS File Delivery over Unidirectional Transport (FLUTE) channel.

As another example, for a Wi-Fi network, middleware unit 122 may perform a domain name service (DNS) lookup to discover a broadcast service on the Wi-Fi network. The DNS lookup may indicate a unicast or multicast Internet protocol (IP) address and port for a service discovery channel. Middleware unit 122 may then retrieve a service announcement from the service discovery channel.

After discovering services (that is, sets of media data) available via the various networks, e.g., networks 104, 106, middleware unit 122 may store information indicative of the services and which network(s) the services are available from, e.g., in a service repository (not shown in FIG. 1). The service repository may be implemented in the form of a database, such as a relational database. The service repository may include records indicative of both an identifier of a service (e.g., a name of the service), as well as the network(s) from which the service is available. Furthermore, the service repository may store an indication of a type for each of the networks, e.g., whether the network is a Wi-Fi network, a 3G network, a 4G network, an eMBMS network, or the like.

As noted above, in some instances, client device 110 may be communicatively coupled to two or more networks simultaneously. However, typically, client device 110 will only be connected to one network of a given type at a particular time. For example, client device 110 may be capable of connecting to a Wi-Fi network and an eMBMS network simultaneously, but may only be capable of connecting to a single Wi-Fi network and a single eMBMS network simultaneously. Nevertheless, if additional networks of the same type are available, middleware unit 122 may nevertheless determine services of each of the available networks.

In accordance with the techniques of this disclosure, middleware unit 122 may form groups of services that can be accessed together. Each group may include the union of all services available from a single network of each type. For example, assuming that there are two Wi-Fi networks, A and B, and two eMBMS networks, C and D, available, middleware unit 122 may assemble four groups of services: 1) the services available from A and C, 2) the services available from A and D, 3) the services available from B and C, and 4) the services available from B and D. Middleware unit 122 may then provide indications of these groups to media application 124, e.g., as part of the list of available services. Accordingly, a user may be able to quickly identify which services can be accessed together. Thus, the user may select a group including services that the user may want to switch between.

In this manner, by implementing the techniques of this disclosure, middleware unit 122 may provide consolidated access to broadcast content over different networks to media application 124. Thus, media application 124 may obtain media data for various services from different networks without needing to be equipped to utilize the different networks. These techniques may therefore be used when broadcast content is available over different networks. In general, the type of network (and/or source of media data) is irrelevant to media application 124.

Accordingly, client device 40 represents an example of a device for retrieving media data, the device comprising a middleware unit configured to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

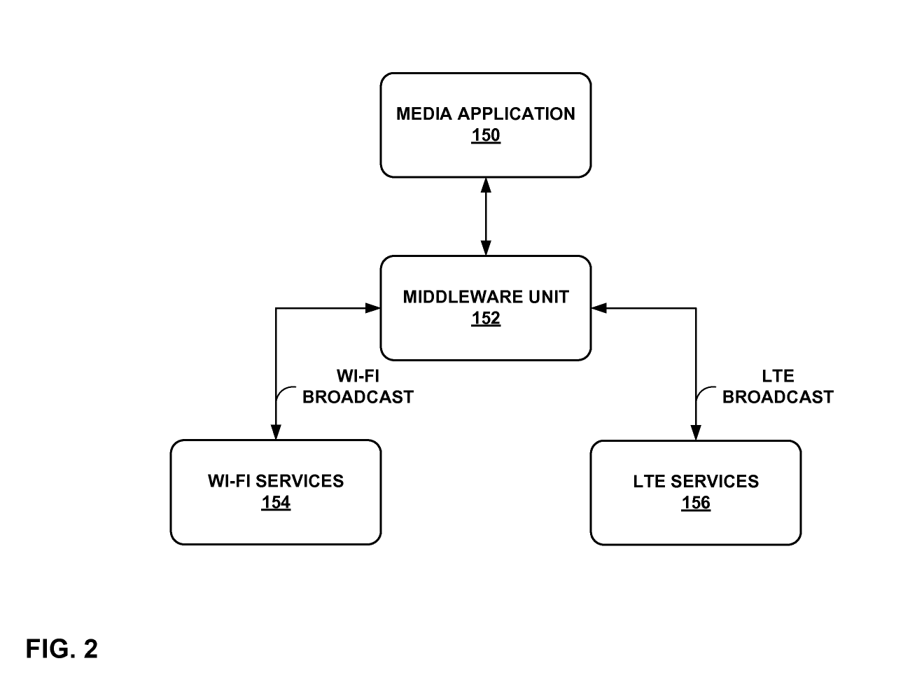

FIG. 2 is a conceptual diagram illustrating an example arrangement of units in accordance with the techniques of this disclosure. The example of FIG. 2 includes media application 150 (which may correspond to media application 124 of FIG. 1), middleware unit 152 (which may correspond to middleware unit 122 of FIG. 1), Wi-Fi services 154, and LTE services 156. With respect to the example of FIG. 1, Wi-Fi services 154 and LTE services 156 may be provided by respective network interfaces 112.

In general, middleware unit 152 may receive media data of Wi-Fi services 154 via a Wi-Fi broadcast, while middleware unit 152 may receive media data of LTE services via an LTE broadcast. In accordance with the techniques of this disclosure, middleware unit 152 may determine whether respective networks (e.g., a Wi-Fi network and an LTE network) include one or more broadcast services. For instance, middleware unit 152 may request a service discovery file from respective devices on the Wi-Fi network and the LTE network. The service discovery file, when available, includes data indicative of services (e.g., media channels and/or files) available for broadcast reception via the respective network.

When middleware unit 152 determines that a service discovery file is available for a particular network, middleware unit 152 may inspect the service discovery file to determine which services are available via the corresponding network. Middleware unit 152 may then form a list of aggregated services, e.g., a set of data defining all services that are currently available by any of the networks (e.g., via the Wi-Fi broadcast and via the LTE broadcast, in the example of FIG. 2). Middleware unit 152 may provide this list to media application 150. In response to receiving a selection of a service from media application 150, middleware unit 152 may obtain media data for the selected service and provide the media data to media application 150.

In some examples, media application 150 may implement a dynamic adaptive streaming over HTTP (DASH) client, while middleware unit 152 may implement a DASH server or DASH proxy. Thus, to provide the media data to media application 150, media application 150 may request the media data from middleware unit 152 by addressing an HTTP GET or partial GET request to a localhost network interface, such that the request is sent to middleware unit 152. Middleware unit 152, in turn, may respond to the request by sending requested media data to media application 150.

Although Wi-Fi services 154 and LTE services 156 are shown in the example of FIG. 2, it should be understood that other types of services may be available. For instance, wired Ethernet services, eMBMS services, and the like may also be available.

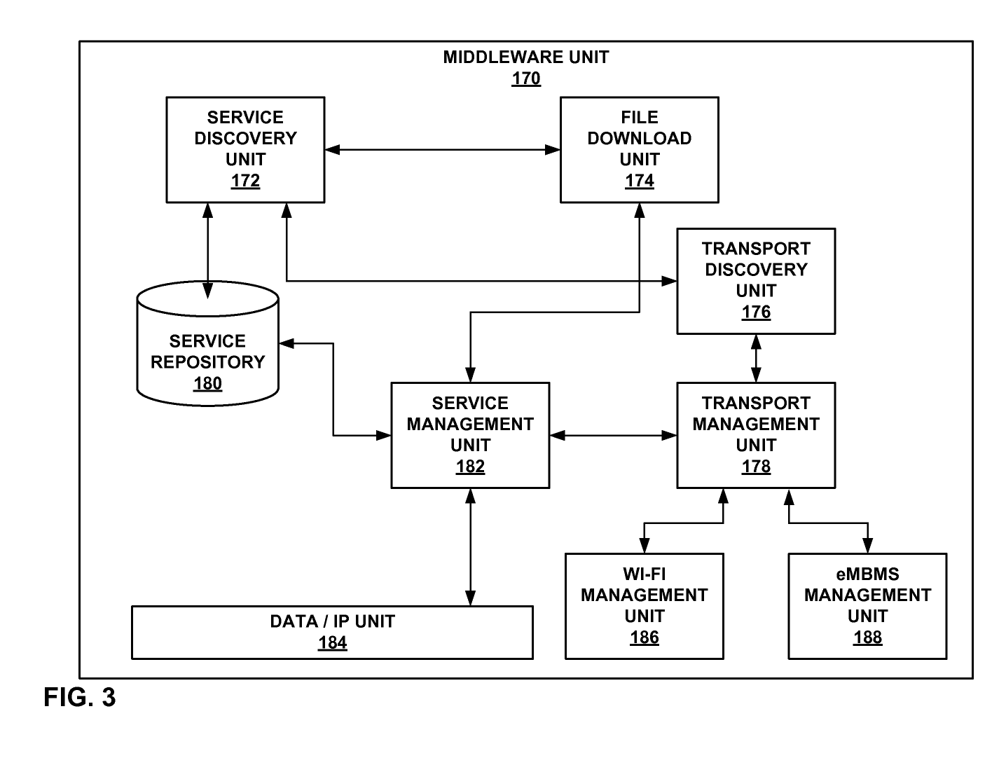

FIG. 3 is a block diagram illustrating an example arrangement of components for middleware unit 170 in accordance with the techniques of this disclosure. Middleware unit 122 of FIG. 1 and/or middleware unit 152 of FIG. 2 may include components substantially similar to those of middleware unit 170 of FIG. 3.

In this example, middleware unit 170 includes service discovery unit 172, file download unit 174, service repository 180, transport discovery unit 176, transport management unit 178, service management unit 182, data/IP unit 184, Wi-Fi management unit 186, and eMBMS management unit 188. Transport discovery unit 176 determines which types of transports (e.g., Wi-Fi, LTE, eMBMS, wired Ethernet, or the like) are available at a particular time. Transport discovery unit 176 may send data to transport management unit 178 indicative of the available transports.

Transport management unit 178 may instantiate a management unit for each of the various transports determined to be available. In the example of FIG. 3, transport management unit 178 instantiates Wi-Fi management unit 186 and eMBMS management unit 188. However, fewer or additional management units may be instantiated for fewer or additional available transports, e.g., for wired Ethernet, LTE, or the like.

Transport discovery unit 176 may also send data to service discovery unit 172 indicative of the available transports. Service discovery unit 172 may then determine whether broadcast services are available via the respective transports, and if so, determine which services are available. A service may correspond to a particular set of media data, which may have fixed or indefinite duration. Service discovery unit 172 may assemble a list of discovered services and store this list in service repository 180, along with an indication of which of the transports each service is available from. Service repository 180 may be implemented as a database, e.g., a relational database. Service discovery unit 172 may also provide the list of available services to file download unit 174.

File download unit 174 may provide the list of available services to an application, such as media application 124 (FIG. 1) or media application 150 (FIG. 2). File download unit 174 may also receive a selection of one of the services from the application. In response to receiving the selection, file download unit 174 may provide data indicative of the selected service to service management unit 182. Service management unit 182, in turn, may determine the transport (e.g., the network) from which the service is available. Service management unit 182 may send an instruction to transport management unit 178 to activate the determined transport, and then retrieves data from the determined transport via data/IP unit 184.

Service discovery unit 172 may discover services in different ways, depending on which type of transport/network is being inspected. For instance, for eMBMS, service discovery unit 172 may perform a bootstrapping procedure to retrieve service discovery channel information from a provisioned unicast location. Service discovery unit 172 may download a service announcement over a service discovery eMBMS File Delivery over Unidirectional Transport (FLUTE) channel. FLUTE is described in T. Paila et al., “FLUTE—File Delivery over Unidirectional Transport,” RFC 3926, Internet Engineering Task Force (IETF), October 2004, available at http://tools.ietf.org/html/rfc3926, and T. Paila et al., “FLUTE—File Delivery over Unidirectional Transport,” RFC 6726, Internet Engineering Task Force (IETF), November 2012, available at http://tools.ietf.org/html/rfc6726. Service discovery unit 172 may parse and interpret the service announcement in accordance with the eMBMS standard.

When service discovery unit 172 discovers a service in the eMBMS service announcement, service discovery unit 172 may add an indication of the service to service repository 180, along with an indication that the service is an eMBMS service. Service discovery unit 172 may also add a name or other identifier for the network to service repository 180, in the event that there is more than one available network of a particular type (e.g., more than one Wi-Fi network, more than one eMBMS network, more than one LTE network, etc.)

Similarly, service discovery unit 172 may discover services available via Wi-Fi networks (i.e., Wi-Fi transport). In some examples, service discovery unit 172 may discover broadcast services available via Wi-Fi transport using a domain name service (DNS). The DNS may provide a unicast or multicast IP/port for a service discovery channel for the Wi-Fi network. Thus, service discovery unit 172 may retrieve data from the service discovery channel indicated by the DNS, to obtain a service announcement. Service discovery unit 172 may also add the available services to service repository 180, along with indications that these services are Wi-Fi services (as well as identifiers for the networks).

File download unit 174 provides file download services for middleware unit 170, as discussed above. Services information may be maintained in a common repository, e.g., service repository 180. The services information may include data indicating a corresponding transport type for the service (e.g., Wi-Fi, eMBMS, LTE, etc.), as well as an identifier for the corresponding network, in some examples. Upon activation of a service, service management unit 182 may activate the corresponding transport controller, e.g., one of Wi-Fi management unit 186 or eMBMS management unit 188 via transport management unit 178. Service management unit 182 may then download data via data/IP unit 184.

As discussed above, multiple networks of the same type may be supported. For example, multiple Wi-Fi, eMBMS, LTE, or other such networks may be supported. As discussed above, service information in service repository 180 may include both network type and network name (or network identifier) information. Thus, the service information of service repository 180 may include a set of triplets of the form: {ServiceName, NetworkType, NetworkName}.

In this manner, middleware unit 170 may expose all available services to an application. In addition, in some examples, middleware unit 170 may provide various groups of currently accessible services, depending on device capabilities and currently connected (or “camped”) networks. For instance, a client device including middleware unit 170 may be capable of being concurrently connected to both a Wi-Fi network and an LTE network. Assuming this to be true, if services are available on a Wi-Fi network and an LTE network, middleware unit 170 may advertise a group of services including services available on the Wi-Fi network and on the LTE network. In an example where two Wi-Fi networks are available and one LTE network is available, middleware unit 170 may compile a first group including the services of the LTE network and the first Wi-Fi network, and a second group including the services of the LTE network and the second Wi-Fi network, and provide information defining these groups to the media application.

Digital rights management (DRM) may be handled out of the scope of middleware unit 170. For instance, the media application may be configured to perform DRM processes. An application may query service information (e.g., a network type and/or a network name) for a service, if needed, e.g., to acquire DRM keys.

Likewise, in some examples, content may be replicated across networks for better quality of service (QoS). For example, a service broadcasted on a national eMBMS network may be replicated on a Wi-Fi network for a certain locality to provide better coverage or QoS. In such instances, middleware unit 170 may select whether to retrieve media data for the service from the eMBMS network or the Wi-Fi network.

In this manner, middleware unit 170 represents an example of a middleware unit configured to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

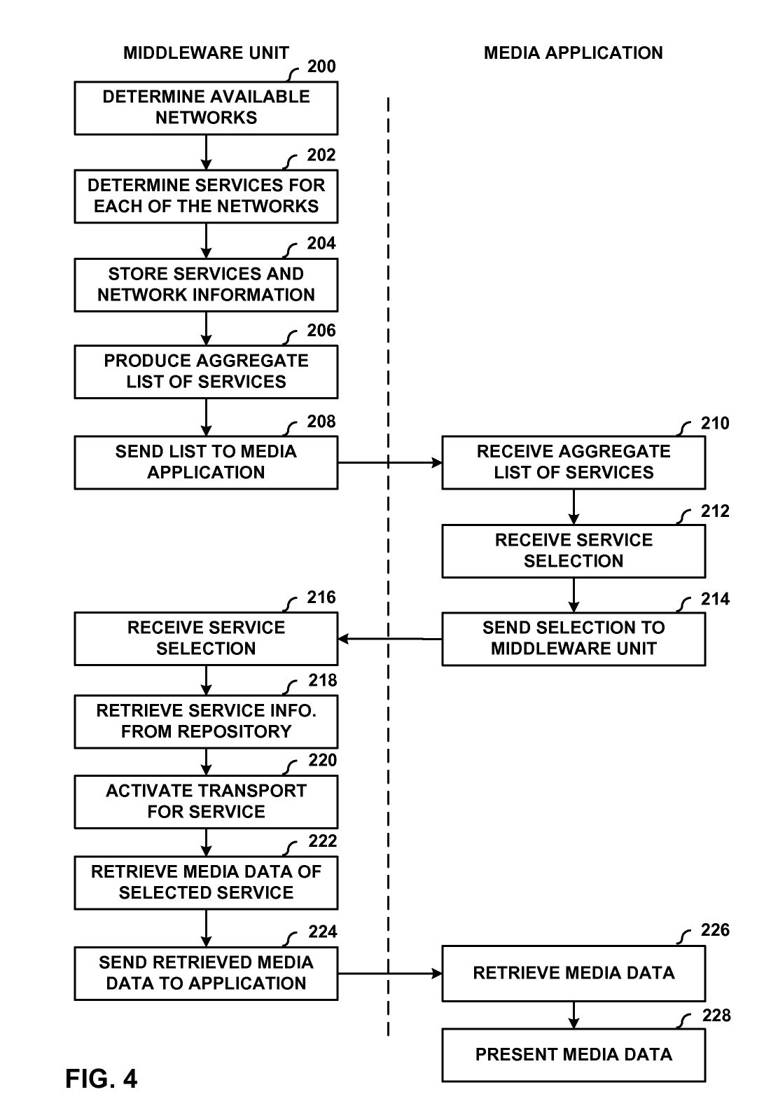

FIG. 4 is a flowchart illustrating an example method for processing media data in accordance with the techniques of this disclosure. The method of FIG. 4 is explained with respect to a middleware unit (e.g., middleware unit 122 of FIG. 1, middleware unit 152 of FIG. 2, or middleware unit 170 of FIG. 3) and a media application (e.g., media application 124 of FIG. 1 or media application 150 of FIG. 2). For purposes of explanation, steps performed by the middleware unit are explained with respect to middleware unit 170 of FIG. 3, while steps performed by the media application are explained with respect to media application 124.

In the example of FIG. 4, middleware unit 170 initially determines available networks (200). For example, transport discovery unit 176 may determine available networks for broadcasting (or multicasting) media data. Middleware unit 170 may then determine services for each of the networks (202). For example, service discovery unit 172 may determine which services are available on each of the networks. As discussed above, different types of networks may support different mechanisms for performing service discovery. For instance, for an eMBMS network, middleware unit 170 may retrieve service discovery channel information from a unicast location and download a service announcement from the service discovery channel. As another example, for a Wi-Fi network, middleware unit 170 may perform a DNS lookup to discover a broadcast service on the Wi-Fi network, where the DNS lookup may indicate a unicast or multicast IP address and port for a service discovery channel from which to obtain a service announcement.

Middleware unit 170 may then store the services and associated network information (e.g., network type and/or network identifier) (204), e.g., in service repository 180. It is assumed, for purposes of this example, that there are at least two networks from which services are available. Middleware unit 170 may store identifiers of the networks (e.g., names of the networks) and services available in each of the networks. In some examples, middleware unit 170 may store types for the networks in service repository 180. Furthermore, if there are two or more networks of the same type, middleware unit 170 may construct groups of services, where each group includes services of only one type of network per available network type. Middleware unit 170 (e.g., service discovery unit 172) may also produce an aggregate list of services, including each of the services from the available networks (206). If there are multiple groups of services, as discussed above, middleware unit 170 may specify the groups in which each service is available as well. Middleware unit 170 may then send the aggregate list of services to media application 124 via file download unit 174 (208).

Media application 124 may receive the aggregate list of services (210). Media application 124 may present data representative of the aggregate list of services to a user, e.g., via user interfaces 130. Media application may then receive a service selection (212), e.g., from the user via user interfaces 130. Media application 124 may then send data representative of the selected service to middleware unit 170 via, e.g., file download unit 174 (214).

Middleware unit 170 may then receive the service selection (216). File download unit 174 may instruct service management unit 182 to retrieve media data of the selected service. Service management unit 182 may retrieve service information from service repository 180 (218), to determine the network from which the selected service is available using data of service repository 180. Service management unit 182 may cause transport management unit 178 to activate the transport on the network corresponding to the selected service (220), and then retrieve media data from the activated transport via data/IP unit 184 for the selected service. Middleware unit 170 may then retrieve media data of the selected service (222). Middleware unit 170 may then send the retrieved media data to media application 124 via file download unit 174 (224).

Media application 124 may then retrieve the media data from middleware unit 170 (226). For example, media application 124 may submit HTTP GET requests (or partial GET requests, if the requests specify byte ranges) to middleware unit 170, to retrieve segments of the media data. Media application 124 may receive the requested segments in response to the HTTP GET requests from middleware unit 170. Media application 124 may also present the media data (228), e.g., via user interfaces 130. For example, media application 124 may present audio data via speakers and video data via a display of user interfaces 130.

In this manner, the method of FIG. 4 represents an example of a method including determining a first set of one or more services available via a first network of a first type, determining a second set of one or more services available via a second network of a second type, wherein the second network is different than the first network, producing an aggregate list of services including the first set of services and the second set of services such that the aggregate list does not identify the first network and does not identify the second network, receiving a selection of a service from the aggregate list of services, and retrieving media data of the selected service from either the first network or the second network.

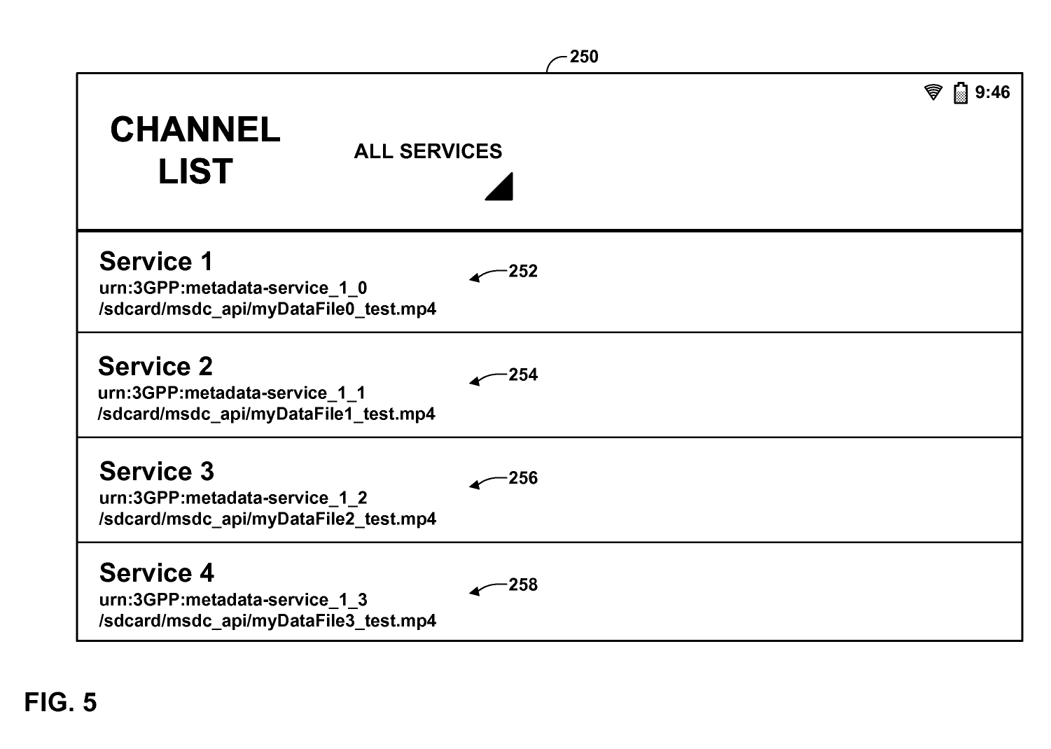

FIG. 5 is a conceptual diagram illustrating an example graphical user interface (GUI) 250 for selecting a service. GUI 250 may be displayed by user interfaces 130 of client device 110 (FIG. 1).

In this example, GUI 250 presents information 252-258 about various services. For example, this information includes a service name and a uniform resource locator (URN) for the service. More particularly, information 252 includes service name “Service 1” and URN “urn:3GPP:metadata-service_{—}1_{—}0/sdcard/msdc_api/myDataFile0_test.mp4.” Information 254 includes service name “Service 2” and URN “urn:3GPP:metadata-service_{—}1_{—}1/sdcard/msdc_api/myDataFile1_test.mp4.” Information 256 includes service name “Service 3” and URN “urn:3GPP:metadata-service_{—}1_{—}2/sdcard/msdc_api/myDataFile2_test.mp4.” Information 258 includes service name “Service 4” and URN “urn:3GPP:metadata-service_{—}1_{—}3/sdcard/msdc_api/myDataFile3_test.mp4.”

As can be seen in the example of FIG. 5, a network from which each of the services is available is not displayed on GUI 250. This is due at least in part to the fact that an application that causes GUI 250 to be displayed does not receive indications of networks from which the services are available, in accordance with the techniques of this disclosure. Accordingly, a user interacting with GUI 250 need not be concerned with the network from which each service is available, because a middleware unit, such as middleware unit 122 (FIG. 1), middleware unit 152 (FIG. 2), or middleware unit 170 (FIG. 3), will determine the network from which each source is available.

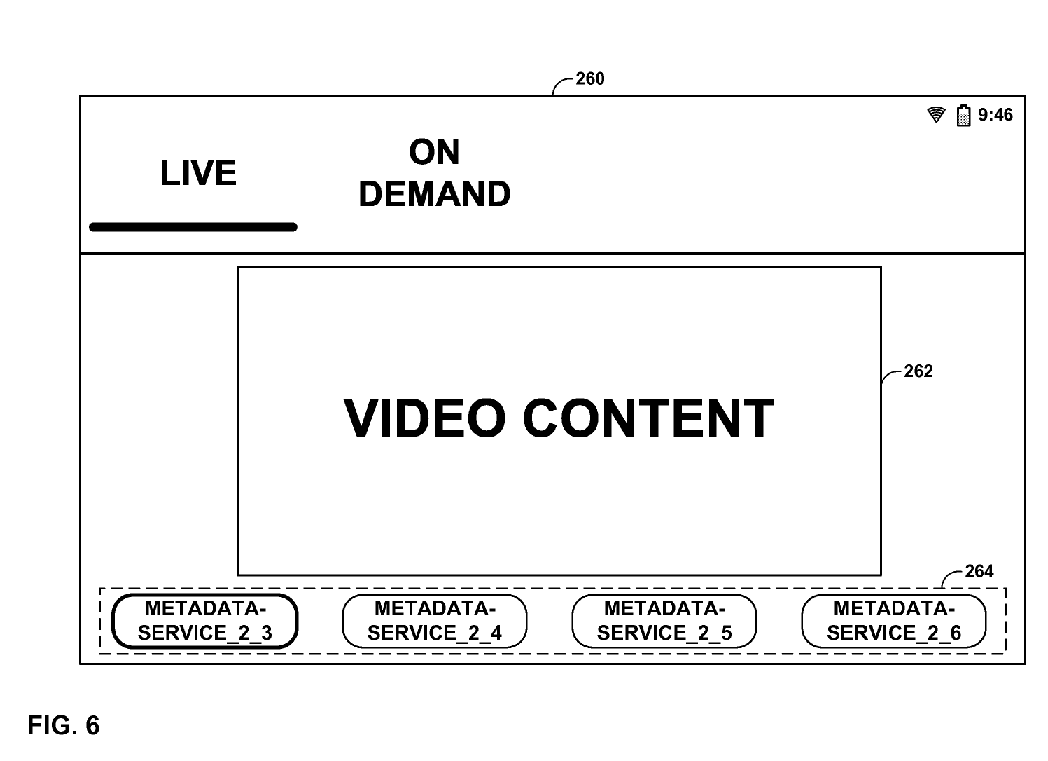

FIG. 6 is a conceptual diagram illustrating an example graphical user interface (GUI) 260 for displaying video content of a selected service. GUI 260 may be displayed by user interfaces 130 of client device 110 (FIG. 1). GUI 260 includes video display region 262, which may present video content of a selected service. GUI 260 also includes selection region 264, which displays a currently selected service (in this example, “metadata-servce_{—}2_{—}3”), as well as other services that can be selected (in this example, “metadata-servce_{—}2_{—}4,” “metadata-servce_{—}2_{—}5,” and “metadata-servce_{—}2_{—}6”).

As with GUI 250 of FIG. 5, GUI 260 of FIG. 6 also does not display a network from which each of the services represented in selection region 264 is available. Again, this is due at least in part to the fact that an application that causes GUI 260 to be displayed does not receive indications of networks from which the services are available, in accordance with the techniques of this disclosure. Because a middleware unit will be responsible for retrieving data for the selected service from an appropriate network, the application that displays GUI 260 need not determine the network from which each service is available.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware. Various examples have been described. These and other examples are within the scope of the following claims.

What is claimed is:

1. A method of retrieving media data, the method comprising, by a middleware unit of a client device:
determining a first set of one or more services available via a first network of a first type;
determining a second set of one or more services available via a second network of a second type, wherein the second network is different than the first network;
producing an aggregate list of services including the first set of services and the second set of services such that the aggregate list does not identify the first network and does not identify the second network;
receiving a selection of a service from the aggregate list of services; and
retrieving media data of the selected service from either the first network or the second network.

2. The method of claim 1, wherein retrieving the media data comprises retrieving the media data from either the first network when the selected service is in the first set of services or from the second network when the selected service is in the second set of services.

3. The method of claim 1, wherein determining the first set of services comprises, when the first type for the first network comprises an enhanced Multimedia Broadcast Multicast Service (eMBMS):
retrieving service discovery channel information from a provisioned unicast location, indicating a service discovery channel; and
downloading a service announcement via the service discovery channel.

4. The method of claim 3, wherein downloading the service announcement comprises downloading the service announcement via a service discovery eMBMS File Delivery over Unidirectional Transport (FLUTE) channel.

5. The method of claim 1, wherein determining the first set of services comprises, when the first type for the first network comprises Wi-Fi:
performing a domain name service (DNS) lookup to discover a broadcast service on the first network, wherein the DNS lookup indicates a unicast or multicast Internet protocol (IP) address and port for a service discovery channel; and
obtaining a service announcement from the service discovery channel.

6. The method of claim 1, further comprising:
adding data representative of the first set of services to a service repository; and
adding data representative of the second set of services to the service repository.

7. The method of claim 6,
wherein adding the data representative of the first set of services comprises, for each of the first set of services, adding data representative of the first type for the first network to the service repository; and
wherein adding the data representative of the second set of services comprises, for each of the second set of services, adding data representative of the second type for the second network to the service repository.

8. The method of claim 6,
wherein adding the data representative of the first set of services comprises, for each of the first set of services, adding data representative of a first identifier for the first network to the service repository; and
wherein adding the data representative of the second set of services comprises, for each of the second set of services, adding data representative of a second identifier for the second network to the service repository.

9. The method of claim 1, further comprising, when the first type and the second type comprise the same type:
forming a first group of services including the first set of services; and
forming a second group of services including the second set of services, wherein the second group is different than the first group.

10. The method of claim 9, further comprising determining a third set of one or more services available via a third network of a third type, wherein the third type is different than the first type and the second type, wherein forming the first group of services comprises forming the first group of services to include the third set of services, and wherein forming the second group of services comprises forming the second group of services to include the third set of services.

11. The method of claim 1, further comprising providing the aggregate list of services to a media application executed by the client device, wherein receiving the selection comprises receiving the selection from the media application.

12. The method of claim 1, wherein the first type and the second type each comprise one of a Wi-Fi network, an enhanced Multimedia Broadcast Multicast Services (eMBMS) network, a Long Term Evolution (LTE) network, third generation (3G) networks, or a wired Ethernet network.

13. A device for retrieving media data, the device comprising a middleware unit configured to determine a first set of one or more services available via a first network of a first type, determine a second set of one or more services available via a second network of a second type, wherein the second network is different than the first network, produce an aggregate list of services including the first set of services and the second set of services such that the aggregate list does not identify the first network and does not identify the second network, receive a selection of a service from the aggregate list of services, and retrieve media data of the selected service from either the first network or the second network.

14. The device of claim 13, further comprising a computer-readable storage medium that stores a service repository, wherein the middleware unit is further configured to add data representative of the first set of services to a service repository, and add data representative of the second set of services to the service repository.

15. The device of claim 14, wherein the middleware unit is configured to add data representative of the first type for the first network to the service repository and to add data representative of the second type for the second network to the service repository.

16. The device of claim 13, wherein the middleware unit is configured to, when the first type and the second type comprise the same type, form a first group of services including the first set of services, and form a second group of services including the second set of services, wherein the second group is different than the first group.

17. The device of claim 13, further comprising a processing unit that executes a media application, wherein the middleware unit is configured to provide the aggregate list of services to the media application and to receive the selection from the media application.

18. A computer-readable storage medium having stored thereon instructions that, when executed, cause a processor implementing a middleware unit of a client device to:
determine a first set of one or more services available via a first network of a first type;
determine a second set of one or more services available via a second network of a second type, wherein the second network is different than the first network;
produce an aggregate list of services including the first set of services and the second set of services such that the aggregate list does not identify the first network and does not identify the second network;
receive a selection of a service from the aggregate list of services; and
retrieve media data of the selected service from either the first network or the second network.

19. The computer-readable storage medium of claim 18, further comprising instructions that cause the processor to:
add data representative of the first set of services to a service repository; and
add data representative of the second set of services to the service repository.

20. The computer-readable storage medium of claim 18, further comprising instructions that cause the processor to, when the first type and the second type comprise the same type:
form a first group of services including the first set of services; and
form a second group of services including the second set of services, wherein the second group is different than the first group.
